(19) United States
(12) Patent Application Publication
(10) Pub. No.: US 2025/0170549 A1
(43) Pub. Date: May 29, 2025

(54) PACKING FOR A ROTATING PACKED BED

(71) Applicant: CARBON CLEAN SOLUTIONS LIMITED, London (GB)

(72) Inventors: Jason DIETERLE, London (GB); David BAHR, London (GB); Thomas YELLAND, London (GB); James HALL, London (GB); Prateek BUMB, London (GB)

(21) Appl. No.: 18/730,416

(22) PCT Filed: Jan. 11, 2023
(86) PCT No.: PCT/GB2023/050042

§ 371 Date: Jul. 19, 2024

Related U.S. Application Data
(60) Provisional application No. 63/300,805, filed on Jan. 19, 2022.

(51) Int. Cl. B01J 19/30; B01D 53/18

(52) U.S. Cl. CPC B01J 19/30; B01D 53/18; B01D 2257/504; B01J 2219/30226; B01J 2219/30296

(57) ABSTRACT

A packing (200, 300, 400, 500) for a rotating packed bed (RPB). The packing includes an elongate central aperture (210, 340, 440, 540). The elongate central aperture (210, 340, 440, 540) extends along at least part of the length of the packing (200, 300, 400, 500). The packing (200, 300, 400, 500) is configured to rotate about an axis (220, 350, 450, 550) which extends along the length of the central aperture (210, 340, 440, 540). A packing body (230, 360, 430, 530) extends around the central aperture (210, 340, 440, 540). The packing body (230, 360, 430, 530) includes a first body portion (240, 310, 420, 520) having a first side profile (250, 320, 410, 510). The packing body (230, 360, 430, 530) further includes a second body portion (260, 370, 460, 560) having a second side profile (270, 380, 470, 570), wherein the second side profile (270, 380, 470, 570) is different from the first side profile (250, 320, 410, 510).

### FIELD

The present disclosure relates to a packing for a Rotating Packed Bed (RPB). The present disclosure more particularly relates to mass transfer processes between liquid and gas phases using Rotating Packed Beds (RPBs) and, in particular, the field of carbon dioxide (CO₂) capture from industrial gas streams.

### BACKGROUND

Gas streams from power plants and other industrial activities include pollutants, for example greenhouse gases. One such greenhouse gas is CO₂ which contributes to the greenhouse effect and global warming.

Static packed beds or columns are used for a variety of chemical processing applications such as absorption, distillation, stripping and liquid-liquid extraction. These static packed beds are filled with packing through which fluids can flow. The packing increases the contact between fluids, thereby increasing the rate of mass transfer.

Advantageously. RPBs provide significantly improved mass transfer performance compared to conventional static packed beds. RPBs can be used in at least distillation, absorption and stripping applications. In an RPB, liquid flows from the inner radius of the packing of the RPB (typically made of structured packing or mesh) to the outer radius, while gas or vapor typically flows counter-current from the outside to the inside, though some cases of co-flow and cross-flow liquid/gas flow regimes are also known to exist. Rotation of the packing results in improved mass transfer by virtue of creating small droplets and thinner liquid films than in conventional beds. Rotation also creates an acceleration potential field (i.e., a centrifugal force) that improves vapor/liquid de-entrainment.

Current RPB designs use cylindrical packed beds with an open inner section. The size of the packed bed is specified by three dimensions: the inner radius, the outer radius, and the axial length. The inner radius and the axial length are selected to stay below the flood point at the inner radius, where liquid and gas superficial velocities are generally the greatest. The outer radius is selected to provide the desired separation.

As shown in FIG. 1, a conventional RPB 10 comprises a housing 20, which includes fluid inlets and outlets. For example, the RPB 10 comprises a gas inlet 30, a gas outlet 40, a liquid inlet 50 and a liquid outlet 60. In other examples, the RPB comprises only liquid inlets and outlets. A packing 70 is rotatably mounted within the housing 20 of the RPB 10. For example, the packing 70 is mounted to a shaft 80, which rotates the packing 70 within the RPB 10.

FIGS. 2 and 3 show a conventional packing 100 of an RPB in more detail. As shown in FIG. 2, the conventional packing 100 comprises a cylindrical packing body 110. Three dimensions specify the size of the packing body 110: an inner radius (rᵢ), an outer radius (rₒ) and an axial length (zᵢ). The inner radius rᵢ defines an elongate central aperture 120 which extends along the length of the packing 100. The packing 100 is configured to rotate about an axis 130 which extends along the length of the packing body 110. The inner radius rᵢ and axial length zᵢ are selected to stay below the flood point at the inner radius rᵢ, where liquid and gas superficial velocities are generally the greatest. The axial length zᵢ is held constant throughout the packing 100 and the outer radius rₒ is selected to provide the desired separation.

This disclosure is directed to an improved packing for an RPB, which seeks to overcome at least some of the limitations of conventional static packed beds and RPBs described herein.

### SUMMARY

The present disclosure provides a packing for a rotating packed bed (RPB), see clause (1) below, wherein the packing comprises an elongate central aperture which extends along at least part of the length of the packing, wherein the packing is configured to rotate about an axis which extends along the length of the central aperture; and a packing body which extends around the central aperture, wherein the packing body comprises: (i) a first body portion having a first side profile and (ii) a second body portion having a second side profile, wherein the second side profile is different from the first side profile. The present disclosure further provides a RPB (see clause (18) below) comprising a housing comprising (A) one or more fluid inlets and one or more fluid outlets, and (B) a packing which is rotatably mounted within the housing, the packing comprising: (i) an elongate central aperture which extends along at least part of the length of the packing, wherein the packing is configured to rotate about an axis which extends along the length of the central aperture and (ii) a packing body which extends around the central aperture, wherein the packing body comprises a first body portion having a first side profile and a second body portion having a second side profile, wherein the second side profile is different from the first side profile (see clause (18) below).

The total volume of a packing for an RPB of some examples of the present disclosure is reduced compared to a conventional packing. In addition, as less material is required, the material cost to fabricate a packing for an RPB is reduced in some examples of this disclosure.

The packing for an RPB of some examples of the present disclosure decreases the shaft power required to accelerate the mass of the packing from stationary to operating speed in a given amount of time. In addition, the required shaft power at constant speed operation would also be reduced, due to the lower rotating packing mass and associated lower friction against bearings and seals.

The packing for an RPB of an example of the present disclosure has an environmental benefit in that it improves the process for capturing CO₂ from power plants and other industrial activities.

The present disclosure further provides preferred embodiments such as the following embodiments.

In any aspect or embodiment described herein, the shape of the first side profile is defined by a radius of the packing body which changes along at least part of the length of the first body portion.

In any aspect or embodiment described herein, the radius of the packing body increases along the length of the first body portion in a direction towards the second body portion.

In any aspect or embodiment described herein, the radius of the packing body changes between a first radius and a second radius at a position along the length of the first body portion.

In any aspect or embodiment described herein, the radius of the packing body changes linearly along at least part of the length of the first body portion.

In any aspect or embodiment described herein, the radius of the first side profile changes non-linearly along the length of the first body portion.

In any aspect or embodiment described herein, the radius of the packing body changes hyperbolically along at least part of the length of the first body portion according to the equation:

$$r ( z ) = {r}_{i} \frac{{z}_{i}}{z} ,$$

where z is an axial length of the packing at any radial position, r is the radius of the packing body, zᵢ is an axial length of the packing at the central aperture and rᵢ is a radius of the central aperture.

In any aspect or embodiment described herein, the non-linear change in the radius is an exponential change in the radius.

In any aspect or embodiment described herein, the shape of the second side profile is defined by a radius of the packing body which changes along at least part of the length of the second body portion.

In any aspect or embodiment described herein, the shape of the second side profile is defined by a radius of the packing body which is substantially constant along at least part of the length of the second body portion.

In any aspect or embodiment described herein, the packing further comprises a third body portion having a third side profile, wherein the shape of the third side profile is defined by a radius of the packing body which changes along at least part of the length of the third body portion.

In any aspect or embodiment described herein, the radius of the packing body changes hyperbolically along at least part of the length of the third body portion according to the equation:

$$r ( z ) = {r}_{i} \frac{{z}_{i}}{z} ,$$

where z is an axial length of the packing at any radial position, r is the radius of the packing body, zᵢ is an axial length of the packing at the central aperture and rᵢ is a radius of the central aperture.

In any aspect or embodiment described herein, the radius of the packing body decreases along the length of the third body portion in a direction away from the second body portion.

In any aspect or embodiment described herein, the radius of the packing body decreases along the length of the third body portion in proportion to an increase in the radius of the packing body along the length of the first body portion.

In any aspect or embodiment described herein, the first body portion and the third body portion are symmetrical about the second body portion.

In any aspect or embodiment described herein, the first body portion and the second body portion are integrally formed.

In any aspect or embodiment described herein, the third body portion and the second body portion are integrally formed.

### BRIEF DESCRIPTION OF THE DRAWINGS

In order that the present disclosure may be more readily understood, preferable embodiments thereof will now be described, by way of example only, with reference to the accompanying drawings, in which:

FIG. 1 is a diagrammatic cross-sectional view of a conventional RPB;

FIG. 2 is a diagrammatic side view of a conventional packing for an RPB;

FIG. 3 is a diagrammatic top view of the conventional packing of FIG. 2;

FIG. 4 is a diagrammatic side view of a packing for an RPB of one example of this disclosure;

FIG. 5 is a diagrammatic top view of the packing of FIG. 4;

FIG. 6 is a diagrammatic side view of a packing for an RPB of one example of this disclosure;

FIG. 7 is a diagrammatic top view of the packing of FIG. 6;

FIG. 8 is a diagrammatic side view of a packing for an RPB of one example of this disclosure;

FIG. 9 is a diagrammatic top view of the packing of FIG. 8;

FIG. 10 is a diagrammatic side view of a packing for an RPB of one example of this disclosure; and

FIG. 11 is a diagrammatic top view of the packing of FIG. 10.

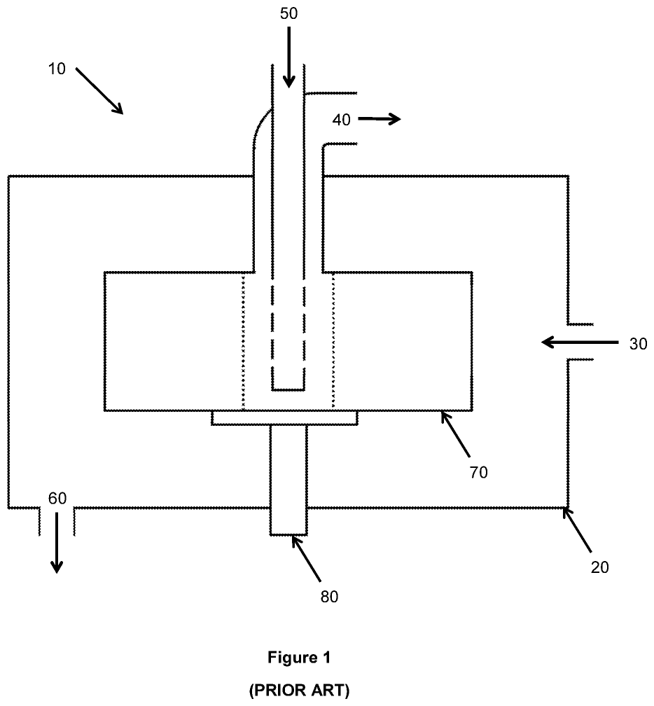

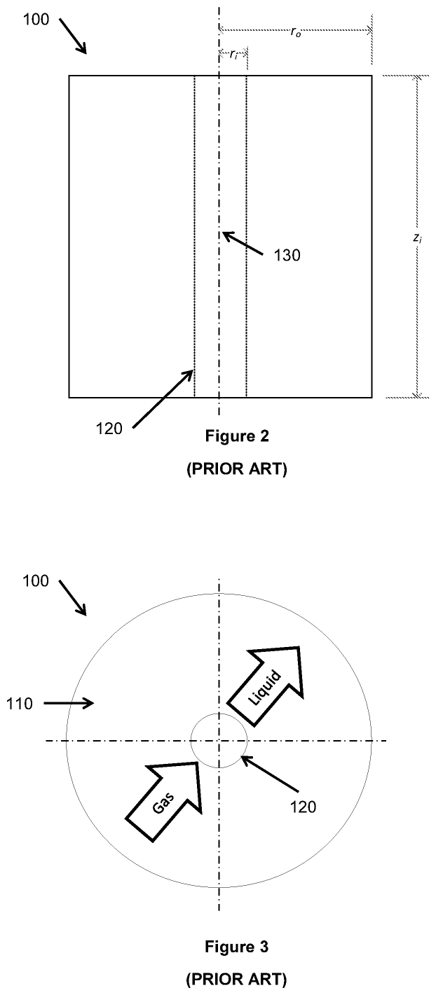

### DETAILED DESCRIPTION

In a conventional cylindrical RPB packing, the cross-sectional area available for flow increases with increasing radial position. It was discovered that this results in low liquid and gas superficial velocities in the packing near the outer radius, which in turn provides worse mass transfer relative to the packing near the inner radius. As a result, most of the overall mass transfer occurs in the inner part of the bed and the outer part of the bed is relatively inefficient.

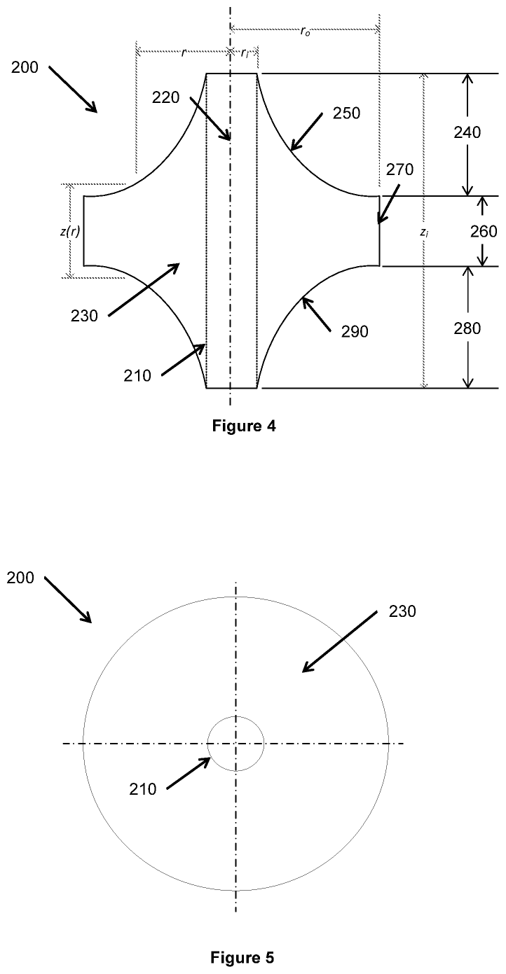

Referring now to FIG. 4, a packing 200 for a RPB of one example of this disclosure comprises an elongate central aperture 210 which extends along the length, zᵢ, of the packing. The packing 200 is configured to rotate about an axis 220 which extends along the length of the central aperture 210. The packing 200 further comprises a packing body 230 which extends around the central aperture 210.

In this example, a tapered shape of the packing 200 is achieved by varying the axial length z with radial position of the packing 200. In one example, the packing body 230 comprises a first body portion 240 having a first side profile 250. The outer surface of the first side profile 250 is solid and fluid does not flow across the profile 250. In one example, the first side profile 250 has a radius which changes along at least part of the length of the first body portion 240.

In one example, the packing body 230 further comprises a second body portion 260 having a second side profile 270, wherein the second side profile 270 is different from the first side profile 250. The second side profile 270 is open and allows for flow across the profile 270. In one example, the second side profile 270 has a radius which changes along at least part of the length of the second body portion 260. In another example, as shown in FIG. 4, the second side profile 270 has a constant radius.

In one example, as shown in FIG. 4, the packing body 230 further comprises a third body portion 280 having a third side profile 290. In this example, the third side profile 290 is the same shape as the first side profile 250.

In the example shown in FIG. 4, the packing 200 has a hyperbolic profile 250. The hyperbolic profile 250 has non-linear change of radius r, where the product of radius r and axial length z is constant along the length of the packing zᵢ. The inner radius defines an elongate central aperture 210 which extends along the length of the packing zᵢ. The packing 200 is configured to rotate about the axis 220 which extends along the length of the central aperture 210. Further, the hyperbolic profile 250 of FIG. 4 has two axes of symmetry. As show in FIG. 5, the hyperbolic profile packing 200 has a circular profile when viewed from above.

In this example, the hyperbolic profile 250 provides a constant cross-sectional area for liquid and gas flow, providing constant superficial velocities and approximately constant mass transfer coefficient. The inner radius (rᵢ) and axial length (zᵢ) at the inner radius are determined based on flooding correlations, or any other appropriate method as known in the art. The axial length of the packing body at any radial position is:

$$z ( r ) = {z}_{i} \frac{{r}_{i}}{r}$$

Alternatively, the radius at any axial length is expressed using the following equation:

$$r ( z ) = {r}_{i} \frac{{z}_{i}}{z}$$

As the mass transfer coefficient would remain high throughout the tapered packing, the total volume of packing would be reduced compared to the conventional hollow, cylindrical packing.

The volume of conventional cylindrical packing 100, V_{cyl}, is calculated using the equation:

$${V}_{cyl} = π {z}_{i} ( {r}_{o}^{2} - {r}_{i}^{2} )$$

The volume of tapered packing 200, V_{tapered}, is calculated using the equation:

$${V}_{tapered} = π {z}_{i} {r}_{i} ( {r}_{o} - {r}_{i} )$$

A comparison between the volumes of the conventional cylindrical packing 100 and tapered packing 200 is expressed by the equation:

$$\frac{{V}_{tapered}}{{V}_{cyl}} = \frac{{r}_{i}}{{r}_{i} + {r}_{o}} \approx 0.15 to 0.25 typical$$

It is shown that the volume of tapered packing 200 is lower than the volume of conventional cylindrical packing 100. The ratio between the volume of tapered packing 200 and volume of conventional cylindrical packing 100 is not definite and is dependent on the profile chosen. The material cost, which is proportional to volume, V, to fabricate the packing for an RPB is reduced. Any installation costs directly related to weight, such as structural steel and foundations, are also reduced.

The tapered shape of the packing 200 according to examples of this disclosure also decreases the required shaft power to accelerate the mass of the packed bed from stationary to operating speed in a given amount of time (proportional to moment of inertia, I). The moment of inertia of conventional cylindrical packing 100, I_{cyl}, with density ρ is calculated using the equation:

$${I}_{cyl} = \frac{1}{2} π ρ {z}_{i} ( {r}_{o}^{4} - {r}_{i}^{4} )$$

The moment of inertia of tapered packing 200, I_{tapered}, is calculated using the equation:

$${I}_{tapered} = \frac{2}{3} π ρ {z}_{i} {r}_{i} ( {r}_{o}^{3} - {r}_{i}^{3} )$$

A comparison between the moments of inertia of the conventional cylindrical packing 100 and tapered packing 200 is expressed by the equation:

$$\frac{{I}_{tapered}}{{I}_{cyl}} = \frac{4 {r}_{i} ( {r}_{o}^{3} - {r}_{i}^{3} )}{3 ( {r}_{o}^{4} - {r}_{i}^{4} )} \approx 0.25 to 0.25 typical$$

It is shown that the moment of inertia of tapered packing 200 is lower than the moment of inertia of conventional cylindrical packing 100. The ratio between the moment of inertia of tapered packing and moment of inertia of conventional cylindrical packing 100 is not definite and is dependent on the profile chosen. Tapered packing 200 reduces the required shaft power at constant speed operation, due to the lower rotating mass and associated lower friction against bearings and seals.

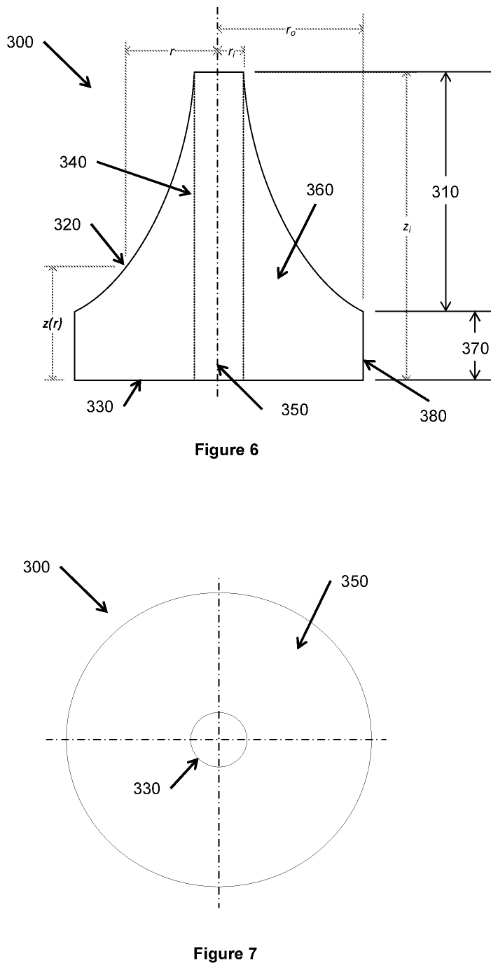

Referring now to FIG. 6, a packing 300 of another example of this disclosure is tapered and has a side profile with non-linear curved portions 310. Such non-linear curved portions 310 are described using a hyperbolic equation, which results in non-linear first side profile 320 with various degrees of rate of change. In one example, the non-linear first side profile 320 is the same as the hyperbolic profile 250. Non-linear curved portions 310 are chosen depending on the application and the desired effects. The non-linear first side profile 320 being solid and does not allow for fluid to flow across the profile 320 in this portion 310. The linear bottom portion 330 is solid and does not allow fluid to flow across the boundary defined by the bottom portion 330. The inner radius defines an elongate central aperture 340, which extends along the length of the packing zᵢ.

The packing 300 is configured to rotate about an axis 350, which extends along the length of the central aperture 340. The packing 300 of FIG. 6 has one axis of symmetry, but is not limited to only one axis of symmetry. Further, as shown in FIG. 7, packing 300 with non-linear curved portions 310 has a circular profile when viewed from above. In one example, the packing body 360 further comprises a second body portion 370 having a second side profile 380, wherein the second side profile 380 is different from the first side profile 320. The second side profile 380 being open and allows for flow across the profile 380. In one example, the second side profile 380 has a radius which changes along at least part of the length of the second body portion 370. In another example, as shown in FIG. 6, the second side profile 380 has a constant radius.

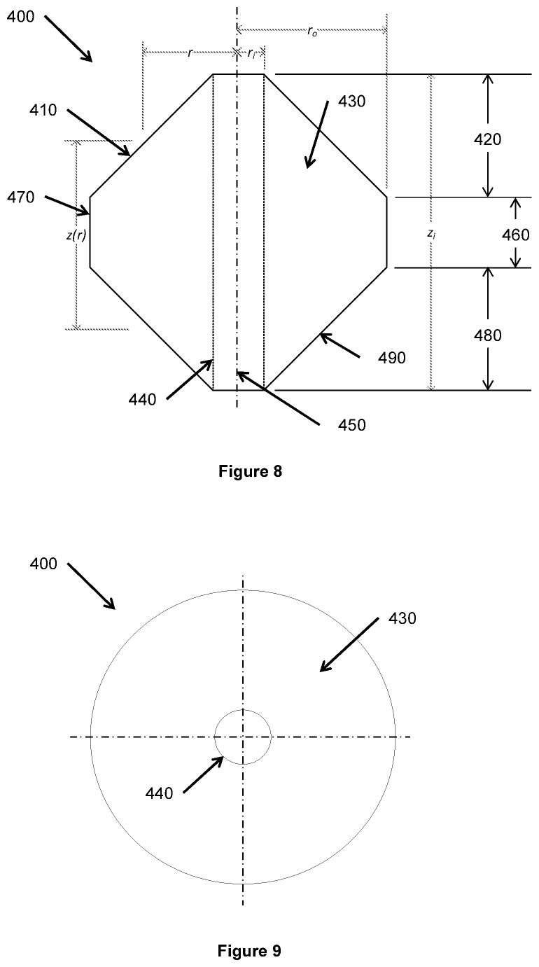

Referring now to FIG. 8, a packing 400 of another example of this disclosure is tapered and has a side profile 410 with linear portions 420. In the linear portions 420, the radius of the packing body changes linearly along the length of the packing body 430. The gradient of the linear portion 420 is chosen depending on the application and the desired effects. The side profile 410 is solid and fluid does not flow across the profile 410 in this portion 420. The inner radius defines an elongate central aperture 440 which extends along the length of the packing 400.

The packing 400 is configured to rotate about an axis 450 which extends along the length of the central aperture 440. The packing 400 of FIG. 8 has two axes of symmetry, but is not limited to only two axes of symmetry. Further, as show in FIG. 9, packing 400 with linear portions 420 has a circular profile when viewed from above. In one example, the packing body 450 that comprises a second body portion 460 having a second side profile 470, wherein the second side profile 470 is different from the first side profile 410. The second side profile 470 being open and allows for flow across the profile 470. In one example, the second side profile 470 has a radius which changes along at least part of the length of the second body portion 460. In another example, as shown in FIG. 8, the second side profile 470 has a constant radius. In one example, the packing body 450 further comprises a third body portion 480 having a third side profile 490, wherein the third side profile 490 is the same as the first side profile 410. The third side profile 490 is solid and fluid does not flow across the profile 490 in this portion 480.

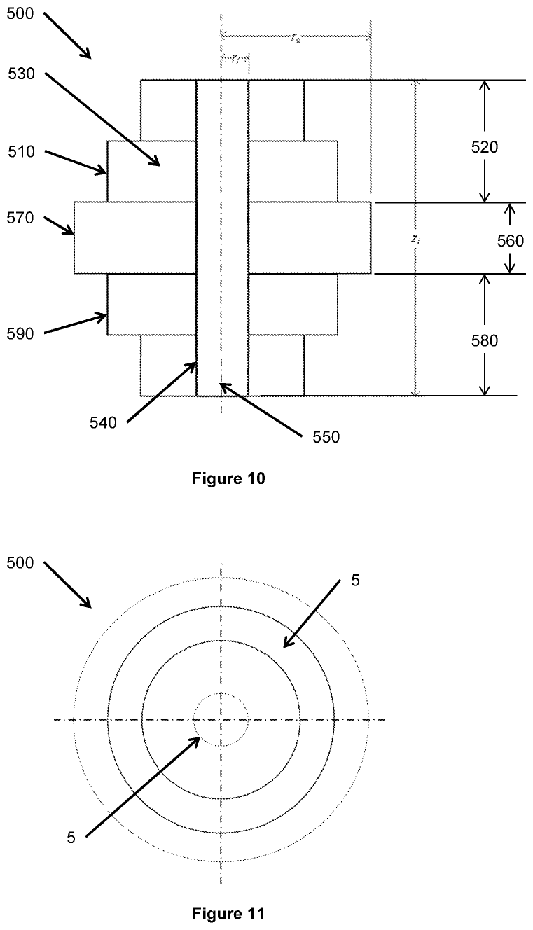

Referring to FIG. 10, a packing 500 of a further example of this disclosure comprises a first stepped profile 510 in a first body portion 520. The radius of the packing body 530 in the first body portion 520 changes between a first radius and a second radius and/or at least one further radius at least at one interval along the length of the axial length, zᵢ, of the packing. The inner radius defines an elongate central aperture 540 which extends along the length of the packing 500.

The packing 500 is configured to rotate about an axis 550 which extends along the length of the central aperture 540. The packing 500 of FIG. 10 has two axes of symmetry, but other examples of this disclosure are not limited to only two axes of symmetry. Further, as shown in FIG. 11, the packing 500 with the stepped portions 520 has a circular profile when viewed from above. In this example, the packing body 530 comprises a second body portion 560 having a second side profile 570, wherein the second side profile 570 is different from the first stepped profile 510. In one example, the second side profile 570 has a radius which changes along at least part of the length of the second body portion 560. In another example, as shown in FIG. 10, the second side profile 570 has a constant radius. In this example, the packing body 530 further comprises a third body portion 580 having a second stepped profile 590, wherein the second stepped profile 590 is the same as the first stepped profile 510.

In other examples, any combination of the profiles for the packing of this disclosure can be used and the disclosure is not limited to using only one particular profile. For example, the packing can be constructed to be symmetrical about a plane perpendicular to the axis of rotation, as shown in FIG. 4, or asymmetrical, as shown in FIG. 6. Further, packing can be constructed of multiple combinations of profiles.

For ease of manufacturing, a tapered packing with linear portions, a stepped profile, or a non-linear curved profile would provide similar advantages for material and installation costs to that of a hyperbolic profile packing 200.

When used in this specification and claims, the terms “comprises” and “comprising” and variations thereof mean that the specified features, steps or integers are included. The terms are not to be interpreted to exclude the presence of other features, steps or components.

The invention of the present disclosure may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the present disclosure have been described, the scope of the appended claims is not intended to be limited solely to these embodiments. The claims are to be construed literally, purposively, and/or to encompass equivalents.

### Representative Features

Representative features are set out in the following clauses, which stand alone or may be combined, in any combination, with one or more features disclosed in the text and/or drawings of the specification.

(Clause 1) A packing for a rotating packed bed (RPB), the packing comprising:
an elongate central aperture which extends along at least part of the length of the packing, wherein the packing is configured to rotate about an axis which extends along the length of the central aperture; and
   a packing body which extends around the central aperture, wherein the packing body comprises:
   a first body portion having a first side profile; and
   a second body portion having a second side profile, wherein the second side profile is different from the first side profile.

(Clause 2) The packing of clause (1), wherein the shape of the first side profile is defined by a radius of the packing body which changes along at least part of the length of the first body portion.

(Clause 3) The packing of clause (2), wherein the radius of the packing body increases along the length of the first body portion in a direction towards the second body portion.

(Clause 4) The packing of clause (2), wherein the radius of the packing body changes between a first radius and a second radius at a position along the length of the first body portion.

(Clause 5) The packing of clause (2), wherein the radius of the packing body changes linearly along at least part of the length of the first body portion.

(Clause 6) The packing of clause (2), wherein the radius of the first side profile changes non-linearly along the length of the first body portion.

(Clause 7) The packing of clause (6), wherein the radius of the packing body changes hyperbolically along at least part of the length of the first body portion according to the equation:

$$r ( z ) = {r}_{i} \frac{{z}_{i}}{z} ,$$

where z is an axial length of the packing at any radial position, r is the radius of the packing body, zᵢ is an axial length of the packing at the central aperture and rᵢ is a radius of the central aperture.

(Clause 8) The packing of clause (6), wherein the non-linear change in the radius is an exponential change in the radius.

(Clause 9) The packing of any one of clauses (1-8), wherein the shape of the second side profile is defined by a radius of the packing body which changes along at least part of the length of the second body portion.

(Clause 10) The packing of any one of clauses (1-8), wherein the shape of the second side profile is defined by a radius of the packing body which is substantially constant along at least part of the length of the second body portion.

(Clause 11) The packing of any one of clauses (1-6), wherein the packing further comprises: a third body portion having a third side profile, wherein the shape of the third side profile is defined by a radius of the packing body which changes along at least part of the length of the third body portion.

(Clause 12) The packing of clause (11), wherein the radius of the packing body changes hyperbolically along at least part of the length of the third body portion according to the equation:

$$r ( z ) = {r}_{i} \frac{{z}_{i}}{z} ,$$

where z is an axial length of the packing at any radial position, r is the radius of the packing body, zᵢ is an axial length of the packing at the central aperture and rᵢ is a radius of the central aperture.

(Clause 13) The packing of clause (11), wherein the radius of the packing body decreases along the length of the third body portion in a direction away from the second body portion.

(Clause 14) The packing of clause (11), wherein the radius of the packing body decreases along the length of the third body portion in proportion to an increase in the radius of the packing body along the length of the first body portion.

(Clause 15) The packing of clause (14), wherein the first body portion and the third body portion are symmetrical about the second body portion.

(Clause 16) The packing of clause (1), wherein the first body portion and the second body portion are integrally formed.

(Clause 17) The packing of clause (11), wherein the third body portion and the second body portion are integrally formed.

(Clause 18) A rotating packed bed (RPB) comprising:
a housing comprising one or more fluid inlets and one or more fluid outlets; and
a packing which is rotatably mounted within the housing, the packing comprising:
   an elongate central aperture which extends along at least part of the length of the packing, wherein the packing is configured to rotate about an axis which extends along the length of the central aperture; and
   a packing body which extends around the central aperture, wherein the packing body comprises:
      a first body portion having a first side profile; and
      a second body portion having a second side profile, wherein the second side profile is different from the first side profile.

1. A packing for a rotating packed bed (RPB), the packing comprising:
an elongate central aperture which extends along at least part of the length of the packing, wherein the packing is configured to rotate about an axis which extends along the length of the central aperture; and
a packing body which extends around the central aperture, wherein the packing body comprises:
a first body portion having a first side profile; and
a second body portion having a second side profile, wherein the second side profile is different from the first side profile.

2. The packing of claim 1, wherein the shape of the first side profile is defined by a radius of the packing body which changes along at least part of the length of the first body portion.

3. The packing of claim 2, wherein the radius of the packing body increases along the length of the first body portion in a direction towards the second body portion.

4. The packing of claim 2, wherein the radius of the packing body changes between a first radius and a second radius at a position along the length of the first body portion.

5. The packing of claim 2, wherein the radius of the packing body changes linearly along at least part of the length of the first body portion.

6. The packing of claim 2, wherein the radius of the first side profile changes non-linearly along the length of the first body portion.

7. The packing of claim 6, wherein the radius of the packing body changes hyperbolically along at least part of the length of the first body portion according to the equation:
$$r ( z ) = {r}_{i} \frac{{z}_{i}}{z} ,$$
where z is an axial length of the packing at any radial position, r is the radius of the packing body, zᵢ is an axial length of the packing at the central aperture and rᵢ is a radius of the central aperture.

8. The packing of claim 6, wherein the non-linear change in the radius is an exponential change in the radius.

9. The packing of claim 1, wherein the shape of the second side profile is defined by a radius of the packing body which changes along at least part of the length of the second body portion.

10. The packing of claim 1, wherein the shape of the second side profile is defined by a radius of the packing body which is substantially constant along at least part of the length of the second body portion.

11. The packing of claim 1, wherein the packing further comprises:
a third body portion having a third side profile, wherein the shape of the third side profile is defined by a radius of the packing body which changes along at least part of the length of the third body portion.

12. The packing of claim 11, wherein the radius of the packing body changes hyperbolically along at least part of the length of the third body portion according to the equation:
$$r ( z ) = {r}_{i} \frac{{z}_{i}}{z} ,$$
where z is an axial length of the packing at any radial position, r is the radius of the packing body, zᵢ is an axial length of the packing at the central aperture and rᵢ is a radius of the central aperture.

13. The packing of claim 11, wherein the radius of the packing body decreases along the length of the third body portion in a direction away from the second body portion.

14. The packing of claim 11, wherein the radius of the packing body decreases along the length of the third body portion in proportion to an increase in the radius of the packing body along the length of the first body portion.

15. The packing of claim 14, wherein the first body portion and the third body portion are symmetrical about the second body portion.

16. The packing of claim 1, wherein the first body portion and the second body portion are integrally formed.

17. The packing of claim 11, wherein the third body portion and the second body portion are integrally formed.

18. A rotating packed bed (RPB) comprising:
a housing comprising one or more fluid inlets and one or more fluid outlets; and
a packing which is rotatably mounted within the housing, the packing comprising:
an elongate central aperture which extends along at least part of the length of the packing, wherein the packing is configured to rotate about an axis which extends along the length of the central aperture; and
a packing body which extends around the central aperture, wherein the packing body comprises:
a first body portion having a first side profile; and
a second body portion having a second side profile, wherein the second side profile is different from the first side profile.
